(19) United States
(12) Patent Application Publication
(10) Pub. No.: US 2011/0076595 A1
(43) Pub. Date: Mar. 31, 2011

(54) DIRECT OXIDATION FUEL CELL

(76) Inventors: Hiroaki MATSUDA, Osaka (JP); Takashi AKIYAMA, Osaka (JP)

(21) Appl. No.: 12/877,588

(22) Filed: Sep. 8, 2010

(30) Foreign Application Priority Data
Sep. 28, 2009 (JP) 2009-223359

(51) Int. Cl. H01M 8/10

(52) U.S. Cl. 429/492

(57) ABSTRACT

A direct oxidation fuel cell includes at least one cell. The cell includes a membrane electrode assembly including an anode, a cathode, and an electrolyte membrane disposed between the anode and the cathode. The cell also includes: an anode-side separator being in contact with the anode and having a fuel flow channel for supplying a fuel to the anode; and a cathode-side separator being in contact with the cathode and having an oxidant flow channel for supplying an oxidant to the cathode. The electrolyte membrane includes an ion exchange resin and has an ion exchange capacity per unit volume which is smaller upstream of the fuel flow channel than downstream thereof.

### FIELD OF THE INVENTION

The invention relates to a direct oxidation fuel cell, and particularly, to an improvement in the structure of an electrolyte membrane for use in a direct oxidation fuel cell.

### BACKGROUND OF THE INVENTION

With mobile devices such as cellular phones, notebook personal computers, and digital cameras having higher performance, fuel cells using solid polymer electrolyte membranes are expected to be used as the power source for such devices. Among solid polymer electrolyte fuel cells (hereinafter referred to as simply “fuel cells”), direct oxidation fuel cells, which supply a liquid fuel such as methanol directly to the anode, are suited for miniaturization, and are being developed as the power source for mobile devices.

Fuel cells include membrane electrode assemblies (MEAs). An MEA is composed of a polymer electrolyte membrane disposed between an anode and a cathode. The anode comprises an anode catalyst layer and an anode diffusion layer, while the cathode comprises a cathode catalyst layer and a cathode diffusion layer. The MEA is sandwiched between a pair of separators to form a cell. The anode-side separator has a fuel flow channel for supplying a fuel such as hydrogen or methanol to the anode. The cathode-side separator has an oxidant flow channel for supplying an oxidant such as oxygen or air to the cathode.

Direct oxidation fuel cells have some problems to be solved, one of which is deterioration in power generation characteristics and power generation efficiency. There are several causes of deterioration in power generation characteristics such as voltage produced and power generation efficiency such as fuel efficiency, and one of them is fuel crossover. When methanol is used as the fuel, methanol crossover (MCO) occurs. MCO is a phenomenon in which methanol (fuel) supplied to the anode migrates to the cathode through the electrolyte membrane.

It should be noted that hydrogen gas is difficult to dissolve in water, compared with methanol. Thus, when a polymer electrolyte fuel cell using hydrogen gas as the fuel is compared with a polymer electrolyte fuel cell using methanol or a methanol aqueous solution as the fuel, hydrogen gas is less likely to migrate to the cathode through the electrolyte membrane. That is, fuel crossover is evident when a liquid fuel such as methanol or a methanol aqueous solution is used as the fuel.

Crossover of a liquid fuel such as methanol lowers the cathode potential, thereby decreasing the output. Also, the liquid fuel having migrated to the cathode through the electrolyte membrane reacts with the oxidant, so extra oxidant is consumed. As a result, downstream of the oxidant flow channel, the oxidant concentration in the cathode lowers, and the output decreases. At the same time, extra fuel is also consumed, so the power generation efficiency also decreases.

In order to reduce liquid fuel crossover, lowering the liquid fuel permeability of the electrolyte membrane is considered to be effective. However, lowering the liquid fuel permeability of the electrolyte membrane usually results in decreased proton conductivity. Also, the liquid fuel is inherently consumed upstream of the fuel flow channel. Thus, downstream of the fuel flow channel, the fuel concentration is low and the amount of liquid fuel crossover is not large. Therefore, when the liquid fuel permeability of the whole area of the electrolyte membrane is lowered, the liquid fuel crossover is hardly reduced downstream of the fuel flow channel, but the proton conductivity lowers. As a result, the output decreases.

Japanese Laid-Open Patent Publication No. 2003-173798 (Patent Document 1) proposes a solid polymer electrolyte fuel cell using hydrogen as the fuel, in which the thickness of the electrolyte membrane upstream of the fuel flow channel is increased to suppress the crossover of hydrogen gas used as the fuel.

Japanese Laid-Open Patent Publication No. 2005-251491 (Patent Document 2) proposes a solid polymer electrolyte fuel cell system using two or more fuel cells disposed along one oxidant flow channel, wherein the EW (equivalent weight: the reciprocal of the ion exchange capacity per unit weight) of the electrolyte membrane included in the fuel cell disposed upstream of the oxidant flow channel is smaller than the EW of the electrolyte membrane included in the fuel cell disposed downstream of the oxidant flow channel. The technique disclosed in Patent Document 2 intends to control the amount of water produced by the reaction at the cathode.

### BRIEF SUMMARY OF THE INVENTION

However, Patent Documents 1 and 2 cannot suppress liquid fuel crossover.

Patent Document 1 proposes changing the thickness of the electrolyte membrane to control the crossover of hydrogen gas used as the fuel. However, such an approach cannot fully solve the above-noted problem of direct oxidation fuel cells.

Also, a cell and a cell stack basically have a uniform thickness, and the whole stack is clamped by applying a uniform pressure in the thickness direction. Hence, if the thickness of the electrolyte membrane is changed, the thickness of other portion(s) of the MEA, such as a catalyst layer or a diffusion layer, needs to be changed to absorb the change of the thickness of the electrolyte membrane. A change in the thickness of other portion(s) than the electrolyte membrane results in an unnecessary change in the balance of the MEA, thereby lowering the power generation characteristics of the whole fuel cell.

Further, the amount of crossover of a liquid fuel in a direct oxidation fuel cell is significantly large, compared with that of hydrogen gas, because the liquid fuel, which is often water-soluble, easily permeates the electrolyte membrane that easily becomes impregnated with water. Therefore, in the case of direct oxidation fuel cells, in order to reduce liquid fuel crossover, it is necessary to make the thickness of the portion of the electrolyte membrane in the vicinity of the fuel flow channel inlet significantly greater than the thickness of the other portions, compared with the technique of Patent Document 1 using hydrogen gas as the fuel. However, such a large change in the thickness of the electrolyte membrane is not preferable due to the above-described reason.

The technique disclosed in Patent Document 2 intends to control the amount of water in the cathode. Thus, the technique of optimizing the EW values disclosed in Patent Document 2 does not intend to suppress liquid fuel crossover in a direct oxidation fuel cell using a liquid fuel, nor does this technique suggest a solution to liquid fuel crossover.

It is therefore an object of the invention to improve the power generation characteristics and power generation efficiency of a direct oxidation fuel cell by controlling the liquid fuel permeability of the electrolyte membrane to reduce liquid fuel crossover.

One aspect of the invention relates to a direct oxidation fuel cell including at least one cell. The cell includes a membrane electrode assembly including an anode, a cathode, and an electrolyte membrane disposed between the anode and the cathode. The cell also includes: an anode-side separator being in contact with the anode and having a fuel flow channel for supplying a fuel to the anode; and a cathode-side separator being in contact with the cathode and having an oxidant flow channel for supplying an oxidant to the cathode. The electrolyte membrane includes an ion exchange resin and has an ion exchange capacity per unit volume which is smaller upstream of the fuel flow channel than downstream thereof.

In the invention, the ion exchange capacity of the electrolyte membrane per unit volume is made smaller upstream of the fuel flow channel than downstream thereof. By changing the ion exchange capacity of the electrolyte membrane per unit volume between upstream and downstream of the fuel flow channel, the permeability of a liquid fuel such as methanol and proton conductivity can be changed. Specifically, upstream of the fuel flow channel, the crossover of the liquid fuel through the electrolyte membrane can be reduced, and downstream of the fuel flow channel, the proton conductivity of the electrolyte membrane can be secured. That is, over the whole electrolyte membrane, occurrence of liquid fuel crossover and deterioration of power generation characteristics can be effectively controlled. Therefore, the invention can suppress both an output decrease by liquid fuel crossover and an output decrease by lowered proton conductivity. It is thus possible to significantly improve the power generation characteristics (e.g., voltage produced) and power generation efficiency (e.g., fuel efficiency) of the fuel cell.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of a direct oxidation fuel cell according to an embodiment of the invention.

FIG. 2 is an enlarged view of the main part of the direct oxidation fuel cell illustrated in FIG. 1.

FIG. 3 is a schematic front view of an electrolyte membrane included in a direct oxidation fuel cell according to an embodiment of the invention.

### DETAILED DESCRIPTION OF THE INVENTION

The fuel cell of the invention includes: a membrane electrode assembly including an anode, a cathode, and an electrolyte membrane disposed between the anode and the cathode; an anode-side separator having a fuel flow channel for supplying a fuel to the anode; and a cathode-side separator having an oxidant flow channel for supplying an oxidant to the cathode. The anode includes an anode catalyst layer disposed on the electrolyte membrane side and an anode diffusion layer disposed on the anode-side separator side. The electrolyte membrane includes an ion exchange resin. The ion exchange capacity of the electrolyte membrane per unit volume is smaller upstream of the fuel flow channel than downstream thereof.

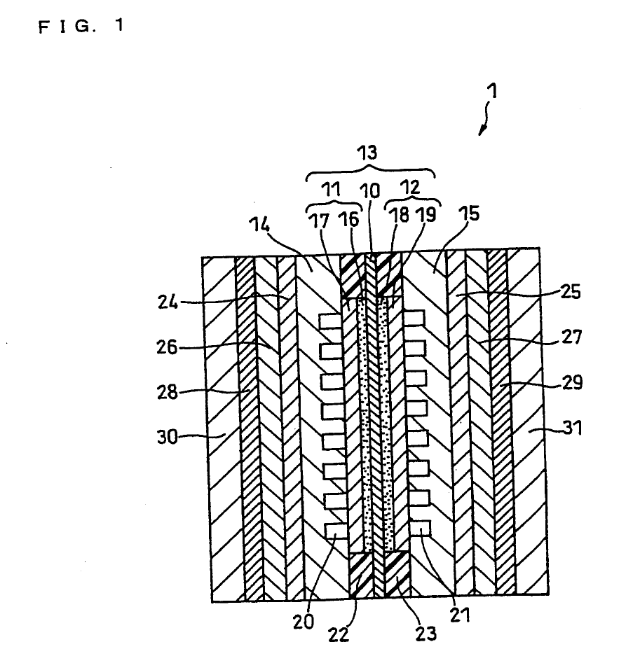

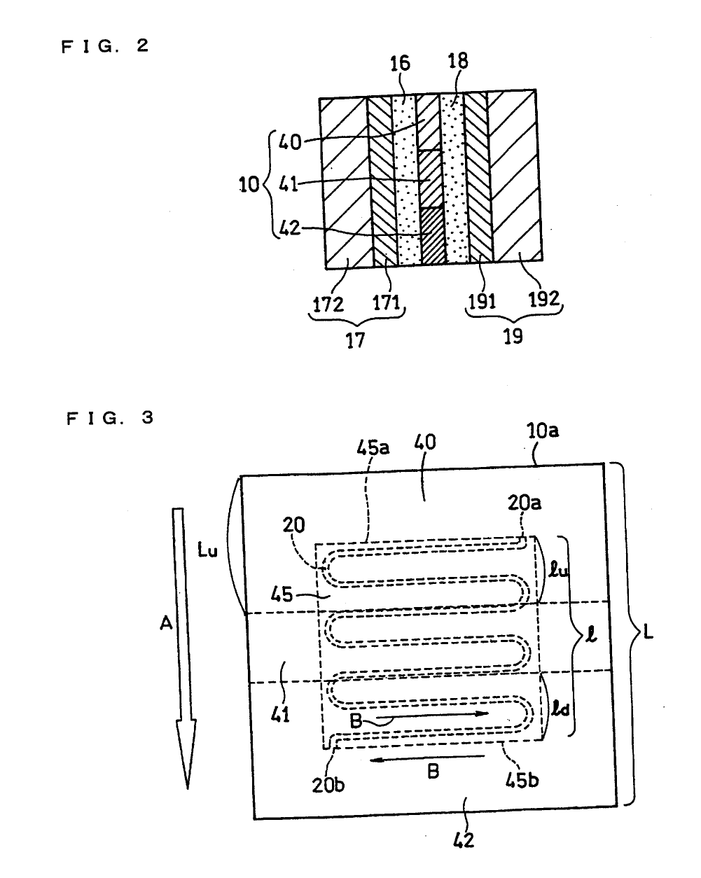

The invention is hereinafter described with reference to drawings. FIG. 1 is a schematic longitudinal sectional view of a direct oxidation fuel cell according to an embodiment of the invention. FIG. 2 is an enlarged view of the main part of the direct oxidation fuel cell illustrated in FIG. 1. A fuel cell 1 of FIG. 1 has a membrane electrode assembly (MEA) 13 including an anode 11, a cathode 12, and an electrolyte membrane 10 interposed between the anode 11 and the cathode 12. A gasket 22 is fitted to one side of the membrane electrode assembly 13 so as to seal the anode 11, while a gasket 23 is fitted to the other side so as to seal the cathode 12. The membrane electrode assembly 13 is sandwiched between an anode-side separator 14 and a cathode-side separator 15. The anode-side separator 14 has a fuel flow channel 20 for supplying a fuel to the anode 11. The cathode-side separator 15 has an oxidant flow channel 21 for supplying an oxidant to the cathode 12.

The anode 11 includes an anode catalyst layer 16 in contact with the electrolyte membrane 10 and an anode diffusion layer 17 in contact with the anode-side separator 14. The anode diffusion layer 17 includes a conductive water-repellent layer 171 in contact with the anode catalyst layer 16 and a substrate layer 172 in contact with the anode-side separator 14.

The cathode 12 includes a cathode catalyst layer 18 in contact with the electrolyte membrane 10 and a cathode diffusion layer 19 in contact with the cathode-side separator 15. The cathode diffusion layer 19 includes a conductive water-repellent layer 191 in contact with the cathode catalyst layer 18 and a substrate layer 192 in contact with the cathode-side separator 15.

The electrolyte membrane 10 has a low capacity region 40 with an ion exchange capacity per unit volume of 0.3 to 1.2 meq/cm³ and a high capacity region 42 with an ion exchange capacity per unit volume of 1.3 to 2.5 meq/cm³. Between the low capacity region 40 and the high capacity region 42 is a middle capacity region 41 whose ion exchange capacity per unit volume is between the low capacity region 40 and the high capacity region 42.

The fuel cell 1 of FIG. 1 can be produced, for example, by the following method. The membrane electrode assembly 13 is produced by bonding the anode 11 to one face of the electrolyte membrane 10 and the cathode 12 to the other face by hot pressing or the like. The membrane electrode assembly 13 is then sandwiched between the anode-side separator 14 and the cathode-side separator 15. At this time, the gasket 22 is fitted between the electrolyte membrane 10 and the anode-side separator 14 to seal the anode 11 of the membrane electrode assembly 13 with the gasket 22, while the gasket 23 is fitted between the electrolyte membrane 10 and the cathode-side separator 15 to seal the cathode 12 with the gasket 23. Thereafter, the anode-side separator 14 and the cathode-side separator 15 are sandwiched between current collector plates 24 and 25, heaters 26 and 27, insulator plates 28 and 29, and end plates 30 and 31, respectively, and they are clamped. In this way, the fuel cell 1 can be produced.

The electrolyte membrane 10 includes an ion exchange resin. The ion exchange resin includes a proton conductive polymer having an ion exchange group such as an acid group, a basic group, or a salt thereof. The ion exchange resin is usually a cation exchange resin having a strong acid group such as a sulfonic acid group, a phosphonic acid group, a phosphoric acid group, or a salt thereof. The ion exchange resin can be, for example, any material commonly used in the field of fuel cells. The ion exchange resin can be, for example, a homopolymer of a monomer having an ion exchange group, a copolymer using such a monomer, or a resin prepared by introducing an ion exchange group to a resin.

Specifically, the ion exchange resin is preferably an ion exchange resin having a sulfonic acid group as the ion exchange group. Such examples are: resins having a perfluoroalkyl group having a sulfonic acid group (perfluorosulfonic acid resins); and sulfonated hydrocarbon resins. Examples of perfluorosulfonic acid resins include Nafion® and Flemion®. Examples of sulfonated hydrocarbon resins include resins having a hydrocarbon unit (excluding a perfluoroalkyl group) with a sulfonic acid group, such as sulfonated styrene resins (e.g., sulfonated styrene-divinylbenzene copolymer), sulfonated polyetherketone resins (e.g., sulfonated polyetherketone and sulfonated polyetheretherketone), and sulfonated polyimides. These ion exchange resins can be used singly or in combination.

In the direct oxidation fuel cell according to the invention, the ion exchange capacity of the electrolyte membrane per unit volume is smaller upstream of the fuel flow channel than downstream thereof. That is, the ion exchange capacity per unit volume changes in the plane direction of the electrolyte membrane. The ion exchange capacity may be increased continuously or stepwise from upstream toward downstream of the fuel flow channel. It is preferable to change the ion exchange capacity stepwise. When the ion exchange capacity is changed stepwise, the production process of the electrolyte membrane becomes easy, and the ion exchange capacity per unit volume can be easily controlled. It is preferable to change the ion exchange capacity of the electrolyte membrane per unit volume, for example, in 2 to 10 stages. It is more preferable to change it in 2 to 5 stages.

Ion exchange capacity usually refers to a numerical value obtained by dividing the number (equivalent) of ion exchange groups contained in an ion exchange resin by unit amount of the ion exchange resin. Ion exchange capacity is expressed as a value per unit mass or unit volume, using a unit such as meq/g or meq/cm³.

In the invention, the ion exchange capacity of the electrolyte membrane per unit volume refers to the equivalent of ion exchange groups contained in the electrolyte membrane per unit volume of the electrolyte membrane including an ion exchange resin and other components.

Ion exchange capacity can be determined, for example, by a determination method using neutralization titration. An ion exchange resin contained or used in a predetermined region of an electrolyte membrane is dispersed in a sodium chloride aqueous solution and stirred. The resulting mixture is subjected to a neutralization titration with a sodium hydroxide aqueous solution of predetermined concentration, to determine the amount (equivalent) of protons replaced by sodium ions in the ion exchange resin contained in the predetermined region. This value is divided by the volume of the predetermined region, to obtain the ion exchange capacity of the predetermined region of the electrolyte membrane per unit volume.

The electrolyte membrane 10 preferably has a low capacity region with an ion exchange capacity of 0.3 to 1.2 meq/cm³ upstream of the fuel flow channel. Further, the electrolyte membrane 10 preferably has a high capacity region with an ion exchange capacity of 1.3 to 2.5 meq/cm³ downstream of the fuel flow channel. This is explained with reference to FIG. 3.

FIG. 3 is a schematic front view of an electrolyte membrane included in a direct oxidation fuel cell in an embodiment of the invention. FIG. 3 shows a power generation region 45 (dotted line) together with a serpentine fuel flow channel 20 (dotted line) which the anode catalyst layer and the electrolyte membrane face. The power generation region 45 is an area where the anode and the cathode of the membrane electrode assembly face each other with the electrolyte membrane therebetween. The anode and the cathode usually have the same size, and the power generation region 45 has the same size as, for example, the anode catalyst layer.

The direction of flow of fuel can be explained as: a direction (overall flow direction) from the upstream side of the fuel flow channel 20 (fuel supply side, i.e., fuel inlet 20a side) toward the downstream side (fuel discharge side, i.e., fuel outlet 20b side); and a direction (local flow direction) parallel to the fuel flow channel 20. For example, when the fuel flow channel 20 has a serpentine structure as illustrated in FIG. 3, the overall flow direction of the fuel flow channel 20 from the upstream side toward the downstream side (the direction of arrow A: the average direction in which the fuel concentration decreases) is different from the local flow direction of the fuel flow channel 20 (the direction of arrow B).

In the invention, it is preferable to set the upstream side and the downstream side of the fuel flow channel based on the overall flow direction of fuel, and change the ion exchange capacity of the electrolyte membrane per unit volume between upstream and downstream of the fuel flow channel. In this case, the production process of the electrolyte membrane becomes easy, and the ion exchange capacity of the electrolyte membrane can be easily controlled.

A description is given below of embodiments in which based on the overall flow direction of fuel, the upstream side and the downstream side of the fuel flow channel are set and the ion exchange capacity of the electrolyte membrane per unit volume is changed. However, in the invention, it is also possible to set the upstream side and the downstream side of the fuel flow channel based on the local flow direction of fuel and change the ion exchange capacity of the electrolyte membrane per unit volume. In the following description, the ion exchange capacity is increased stepwise from upstream toward downstream.

The electrolyte membrane 10 of FIG. 3 has the low capacity region 40 with an ion exchange capacity per unit volume of 0.3 to 1.2 meq/cm³ and the high capacity region 42 with an ion exchange capacity per unit volume of 1.3 to 2.5 meq/cm³. In FIG. 3, between the low capacity region 40 and the high capacity region 42 is the middle capacity region 41 whose ion exchange capacity per unit volume is between the low capacity region 40 and the high capacity region 42. The ion exchange capacity per unit volume increases stepwise in the order of the low capacity region 40, the middle capacity region 41, and the high capacity region 42.

The low capacity region 40 preferably overlaps 1/1.5 to 1/10 of the power generation region 45 from an upstream side end 45a of the power generation region 45, or preferably overlaps ⅓ to ⅙ from the end 45a. This is described more specifically. The length of the power generation region 45 parallel to the overall flow direction of fuel (the direction of arrow A) from upstream toward downstream of the fuel flow channel 20 is defined as 1. The low capacity region 40 preferably overlaps a region whose length lu parallel to the direction of arrow A from the upstream side end 45a of the power generation region 45 is 1/1.5 to 1/10, in particular, ⅓ to ⅙. In the ⅓ to ⅙ region from the end 45a of the power generation region 45, particularly large fuel crossover tends to occur. Therefore, reducing fuel crossover in this region significantly contributes to an improvement in power generation characteristics and power generation efficiency.

The high capacity region 42 preferably overlaps 1/1.5 to 1/10 of the power generation region 45 from a downstream side end 45b of the power generation region 45. Specifically, when the length of the power generation region 45 parallel to the direction of arrow A is defined as 1, the high capacity region 42 preferably overlaps a region whose length ld parallel to the direction of arrow A from the downstream side end 45b of the power generation region 45 is 1/1.5 to 1/10.

The ion exchange capacity of the low capacity region 40 per unit volume is 0.3 to 1.2 meq/cm³ as described above, preferably 0.35 to 1 meq/cm³, and more preferably 0.4 to 0.9 meq/cm³.

If the ion exchange capacity per unit volume is too small, the proton conductivity of the low capacity region 40 may become insufficient. If the ion exchange capacity per unit volume is too large, fuel permeability becomes high, so fuel crossover may not be sufficiently reduced.

The ion exchange capacity of the high capacity region 42 per unit volume is 1.3 to 2.5 meq/cm³, preferably 1.35 to 2.3 meq/cm³, and more preferably 1.4 to 2 meq/cm³.

If the ion exchange capacity per unit volume is too small, the proton conductivity of the high capacity region 42 may become insufficient. If the ion exchange capacity per unit volume is too large, fuel crossover may become too large or the strength and/or durability of the ion exchange resin contained in the high capacity region 42 may become insufficient.

The difference in ion exchange capacity per unit volume between the high capacity region 42 and the low capacity region 40 is 0.5 meq/cm³ or more and 2.2 meq/cm³ or less, preferably 0.55 to 2 meq/cm³, and more preferably 0.6 to 1.8 meq/cm³.

When the difference in ion exchange capacity per unit volume between the high capacity region 42 and the low capacity region 40 is set in the above range, it is possible to sufficiently reduce the crossover of the fuel through the low capacity region 40 while maintaining the sufficient proton conductivity of the high capacity region 42. It is therefore possible to further improve the power generation characteristics and power generation efficiency of the fuel cell.

As illustrated in FIG. 3, the middle capacity region 41 may be provided between the low capacity region 40 and the high capacity region 42. When the ion exchange capacity per unit volume increases stepwise, the middle capacity region 41 may be composed only of one region with a uniform ion exchange capacity per unit volume. Alternatively, the middle capacity region 41 may be composed of two or more regions with different ion exchange capacities per unit volume. When the middle capacity region 41 is composed of two or more regions, the ion exchange capacity of the electrolyte membrane 10 per unit volume can be further optimized according to the change in the amount of fuel crossover between the upstream side end 45a and the downstream side end 45b of the power generation region 45.

When the middle capacity region 41 is provided between the low capacity region 40 and the high capacity region 42, the middle capacity region 41 preferably overlaps a region of the power generation region 45 whose length parallel to the arrow A is 1/1.5 to 1/10.

When the middle capacity region 41 is provided between the low capacity region 40 and the high capacity region 42, the ion exchange capacity C_{M} of the middle capacity region 41 per unit volume is selected as appropriate, depending on the ion exchange capacity C_{L} of the low capacity region 40 per unit volume and the ion exchange capacity C_{H} of the high capacity region 42 per unit volume. For example, C_{M} may be selected so that the difference (C_{H}-C_{M}) is almost equal to the difference (C_{M}-C_{L}). Alternatively, it may be selected so that the difference (C_{H}-C_{M}) is larger than the difference (C_{M}-C_{L}), or so that the difference (C_{M}-C_{L}) is larger than the difference (C_{H}-C_{M}). Also, when the middle capacity region 41 is composed of two or more regions, the ion exchange capacities of the respective regions of the middle capacity region 41 per unit volume may also be selected as appropriate.

When the ion exchange capacity per unit volume changes continuously from upstream toward downstream of the fuel flow channel, provided that the length of the electrolyte membrane 10 parallel to the overall flow direction of fuel (the direction of arrow A) in FIG. 3 is defined as L, the ion exchange capacity per unit volume of a region A (corresponding to the low capacity region) with a length Lu parallel to the direction of arrow A from an upstream side end 10a of the electrolyte membrane 10 is preferably in the above-mentioned range of the low capacity region. The region A overlaps a region whose length lu parallel to the direction of arrow A from the upstream side end 45a of the power generation region 45 is 1/1.5 to 1/10, or in particular, ⅓ to ⅙. The ion exchange capacity of the remaining region B (corresponding to the high capacity region) of the electrolyte membrane per unit volume is preferably in the above-mentioned range of the high capacity region.

When the ion exchange capacity per unit volume changes continuously, the ion exchange capacity per unit volume is the average ion exchange capacity of each region per unit volume. In this case, the difference in average ion exchange capacity per unit volume between the region A and the region B of the electrolyte membrane can also be selected from the same range as that for the difference between the low capacity region and the high capacity region.

The ion exchange capacities of the respective regions of the electrolyte membrane 10 per unit volume upstream and downstream of the fuel flow channel can be adjusted by suitably selecting the kind and amount of the ion exchange resin contained in each region and the content of the ion exchange group in the ion exchange resin. Each region may contain one or more ion exchange resins.

A description is hereinafter made of means for changing the ion exchange capacity of the electrolyte membrane per unit volume between upstream and downstream of the fuel flow channel. For example, the following means can be used advantageously.

### (First Means)

A plurality of ion exchange resins with different ion exchange capacities per unit volume are prepared, and a solution (or a dispersion) of each of the ion exchange resins is prepared (such a solution or dispersion may be hereinafter referred to as simply a solution). The prepared solutions of ion exchange resins with different ion exchange capacities are applied onto a predetermined substrate so that the ion exchange capacity increases from upstream of the fuel flow channel toward downstream thereof, to obtain an electrolyte membrane.

### (Second Means)

A plurality of small electrolyte membranes with different ion exchange capacities per unit volume are prepared. These small electrolyte membranes are arranged sequentially so that the ion exchange capacity increases from upstream of the fuel flow channel toward downstream thereof. They are then bonded to obtain an electrolyte membrane.

### (Third Means)

An electrolyte membrane can comprise a sheet-like porous substrate and an ion exchange resin filled in the porous substrate. In this case, the porosity of the porous substrate can be made smaller upstream of the fuel flow channel than downstream thereof (3-1 means). Alternatively, the ion exchange capacity of the ion exchange resin filled in the porous substrate per unit volume can be made smaller upstream of the fuel flow channel than downstream thereof (3-2 means).

Each means is described more specifically.

### (First Means)

First, a plurality of ion exchange resins with different ion exchange capacities per unit volume are prepared. Each ion exchange resin is dissolved in a predetermined solvent to obtain a solution of each ion exchange resin. The prepared solutions are applied onto a predetermined substrate by a method such as doctor blade application or spraying, to form a thin film, which is then dried to obtain an electrolyte membrane. At this time, the solutions are applied sequentially, with a solution of an ion exchange resin with the smallest ion exchange capacity being applied to the upstream of the fuel flow channel, and a solution of an ion exchange resin with the largest ion exchange capacity being applied to the downstream thereof. In this way, the ion exchange capacity of the electrolyte membrane per unit volume can be made smaller upstream of the fuel flow channel than downstream thereof.

For example, in the case of the electrolyte membrane 10 illustrated in FIG. 3, the application area of a substrate is divided into three portions: an upstream portion, a midstream portion, and a downstream portion, which correspond to the low capacity region 40, the middle capacity region 41, and the high capacity region 42, respectively. A solution of an ion exchange resin with the smallest ion exchange capacity per unit volume is applied to the upstream portion. A solution of an ion exchange resin with a middle ion exchange capacity per unit volume is applied to the midstream portion. A solution of an ion exchange resin with the largest ion exchange capacity per unit volume is applied to the downstream portion. In this way, the electrolyte membrane 10 of FIG. 3 can be produced.

When the solution is applied to the upstream portion, the midstream portion and the downstream portion are masked. Likewise, when the solution is applied to each of the midstream portion and the downstream portion, the other portions are masked. In this way, the different ion exchange resin solutions can be applied to the different portions.

The ion exchange capacity of an ion exchange resin per unit volume can be changed, for example, by the following methods. When an ion exchange resin is prepared by polymerizing a monomer with an ion exchange group, the content of the ion exchange group in the ion exchange resin is adjusted. The content of the ion exchange group can be adjusted by adjusting the ratio of the monomer with the ion exchange group or changing the molecular structure of the monomer (e.g., using a monomer with a small molecular weight). When an ion exchange resin is prepared by, for example, sulfonating a resin having no ion exchange group, the conditions for introduction of an ion exchange group (e.g., sulfonation), such as the ratio of raw materials, reaction time, and temperature, are changed to adjust the amount of the ion exchange group introduced.

### (Second Means)

When an electrolyte membrane made of an ion exchange resin has a high temperature, the ion exchange resin becomes fluidized. Thus, a plurality of small electrolyte membranes can be joined by bringing them into contact with one another and applying heat and pressure to the small electrolyte membranes. At this time, a plurality of small electrolyte membranes with different ion exchange capacities per unit volume are used. The small electrolyte membranes are arranged sequentially from a small electrolyte membrane with the smallest ion exchange capacity per unit volume so that the ion exchange capacity increases from upstream of the fuel flow channel toward downstream thereof. In this way, the ion exchange capacity of the electrolyte membrane per unit volume can be made smaller upstream of the fuel flow channel than downstream thereof.

For example, in the case of the electrolyte membrane 10 as illustrated in FIG. 3, the whole area of the electrolyte membrane 10 is divided into three regions: the low capacity region 40, the middle capacity region 41, and the high capacity region 42. A small electrolyte membrane with the smallest ion exchange capacity per unit volume is disposed at a portion corresponding to the low capacity region 40. A small electrolyte membrane with a middle ion exchange capacity per unit volume is disposed at a portion corresponding to the middle capacity region 41. A small electrolyte membrane with the largest ion exchange capacity per unit volume is disposed at a portion corresponding to the high capacity region 42. The contact portions thereof are joined by hot pressing or the like.

Alternatively, the small electrolyte membranes disposed in the above manner can be joined by applying a solution of an ion exchange resin (e.g., the same ion exchange resin as that used for each region) to the vicinity of each small electrolyte membrane and drying it. As described above, the electrolyte membrane 10 of FIG. 3 can be produced.

Each small electrolyte membrane can be produced, for example, as follows. An ion exchange resin is selected according to the ion exchange capacity of each small electrolyte membrane per unit volume. Ion exchange resins are usually available in the form of a solution or a thin film. When a solution of the selected ion exchange resin is used, the solution is applied onto a predetermined substrate and dried to obtain a predetermined small electrolyte membrane. Likewise, another small electrolyte membrane can be prepared by using a solution of an ion exchange resin with a different ion exchange capacity per unit volume. In this way, each small electrolyte membrane can be produced.

When an ion exchange resin in the form of a thin film is used, the thin-film ion exchange resin is cut to obtain a small electrolyte membrane.

### (Third Means)

The electrolyte membrane can include a material which does not contribute to proton conductivity, such as a reinforcing material, in addition to an ion exchange resin. The material which does not contribute to proton conductivity is preferably a sheet-like porous substrate. That is, the electrolyte membrane preferably comprises a sheet-like porous substrate and an ion exchange resin filled in the porous substrate. Such configuration can effectively reduce fuel crossover while securing proton conductivity.

Generally, an ion exchange resin does not exhibit proton conductivity in a dry state, and when it contains water, it exhibits proton conductivity. At this time, due to the change in the molecular structure caused by the water contained therein, the ion exchange resin becomes swollen and its volume increases. A water-soluble fuel such as methanol infiltrates into the water contained in the ion exchange resin, thereby causing crossover. However, in the case of using an electrolyte membrane comprising a porous substrate and an ion exchange resin filled therein, fuel crossover can be reduced, because the increase in the volume of the ion exchange resin swollen with water is suppressed by the mechanical strength of the porous substrate and the content of the water is also suppressed.

An ion exchange resin can be filled in a sheet-like porous substrate, for example, by a method of immersing a porous substrate in a solution of an ion exchange resin and reducing pressure or applying ultrasonic vibrations to impregnate the pores of the porous substrate with the solution of the ion exchange resin. It is also possible to use a method of immersing a porous substrate in a solution of a monomer of an ion exchange resin and polymerizing the monomer in the pores of the porous substrate to obtain an ion exchange resin.

In the case of using an electrolyte membrane comprising a porous substrate and an ion exchange resin, the ion exchange capacity of the electrolyte membrane per unit volume can be changed, for example, by using the 3-1 means and the 3-2 means.

### (3-1 Means)

In this means, the porosity of a sheet-like porous substrate is made lower upstream of the fuel flow channel than downstream thereof. Since the porous substrate has no ion exchange group (e.g., strong acid group), the ion exchange capacity of the electrolyte membrane per unit volume is adjusted by adjusting the amount of the ion exchange resin contained in each portion of the porous substrate. In this means, since the porosity of the porous substrate is smaller upstream of the fuel flow channel, the amount of the ion exchange resin filled in the porous substrate can be made smaller upstream of the fuel flow channel. Therefore, according to this means, the amount of the ion exchange resin contained in the electrolyte membrane per unit volume can be made smaller upstream of the fuel flow channel than downstream thereof.

The porosity of a porous substrate can be made smaller upstream of the fuel flow channel than downstream thereof, for example, by the following methods. In the case of stretching a thin-film substrate to make it porous, the degree of stretching is changed according to the portion of the substrate.

In the case of preparing a thin-film substrate containing a pore-forming material and removing the pore-forming material to make the thin-film substrate porous, the particle size or amount of the pore-forming material to be contained is changed according to the portion of the substrate.

In the case of adding a filler (an organic filler, e.g., an organic polymer having no ion exchange group such as PVDF) to a uniformly porous substrate to change the porosity of the porous substrate, the amount of the filler added is changed according to the portion of the substrate. A filler in the form of a dispersion may be disposed on a porous substrate in advance. Alternatively, a filler may be mixed into a solution containing an ion exchange resin, and the resulting mixture may be applied to a porous substrate.

The porosity of each portion of a porous substrate can be obtained, for example, by measuring the thickness and the weight, calculating the apparent density from the measured values, and dividing the true density by the calculated value. In the case of stretching and using a pore-forming material, the true density of the porous substrate is used as the true density. In the case of using a filler, the true density can be calculated from the true density of the porous substrate, the true density of the filler, and the amount of the filler.

Preferably, the porous substrate has a low-porosity region with a porosity of 20 to 45% upstream of the fuel flow channel (particularly in the portion of the porous substrate corresponding to the low capacity region 40), and has a high-porosity region with a porosity of 50 to 80% downstream of the fuel flow channel. The porosity of the low-porosity region is preferably 25 to 40%. The porosity of the high-porosity region is preferably 55 to 75%.

For example, the electrolyte membrane 10 of FIG. 3 can be produced by using the 3-1 means, as follows. The portions of a porous substrate corresponding to the low capacity region 40, the middle capacity region 41, and the high capacity region 42 of the electrolyte membrane 10 are designated as an upstream portion, a midstream portion, and a downstream portion, respectively. The porosity of each of the upstream portion, midstream portion, and downstream portion of the porous substrate is increased from the upstream portion toward the downstream portion. An ion exchange resin is filled in the porous substrate to obtain the electrolyte membrane 10 of FIG. 3.

In the case of stretching a thin-film substrate to make it porous, the substrate is stretched so that the porosity thereof continuously changes. The use of such a porous substrate can provide an electrolyte membrane whose ion exchange capacity per unit volume increases continuously from upstream toward downstream of the fuel flow channel.

### (3-2 Means)

In this means, the ion exchange capacity of ion exchange resins filled in a porous substrate per unit volume is made smaller upstream of the fuel flow channel than downstream thereof. That is, a plurality of ion exchange resins with different ion exchange capacities per unit volume are used. Specifically, an ion exchange resin with the smallest ion exchange capacity per unit volume is filled in a portion of the porous substrate upstream of the fuel flow channel, while an ion exchange resin with the largest ion exchange capacity per unit volume is filled in a portion of the porous substrate downstream of the fuel flow channel. The ion exchange capacity of the electrolyte membrane per unit volume is determined by the ion exchange capacity of the ion exchange resins filled therein per unit volume. Therefore, according to this means, it is also possible to make the ion exchange capacity of the electrolyte membrane per unit volume smaller upstream of the fuel flow channel than downstream thereof.

In this means, the porosity of the whole porous substrate may be uniform. Alternatively, as in the 3-1 means, the porosity of the portion of the porous substrate upstream of the fuel flow channel may be made lower than that downstream of the fuel flow channel.

For example, the electrolyte membrane 10 of FIG. 3 can be produced by using the 3-2 means, as follows. Three ion exchange resins with different ion exchange capacities per unit volume are prepared. The portions of a porous substrate corresponding to the low capacity region 40, the middle capacity region 41, and the high capacity region 42 of the electrolyte membrane 10 are designated as an upstream portion, a midstream portion, and a downstream portion, respectively. The ion exchange resin with the smallest ion exchange capacity per unit volume, the ion exchange resin with a middle ion exchange capacity per unit volume, and the ion exchange resin with the largest ion exchange capacity per unit volume are filled in the upstream portion, midstream portion, and downstream portion of the porous substrate, respectively. In this way, the electrolyte membrane 10 of FIG. 3 can be produced.

Different kinds of ion exchange resins can be filled in different portions of a porous substrate, for example, by a method of impregnating only a predetermined portion of a porous substrate with a solution of a predetermined ion exchange resin. It is also possible to use a method of masking the other portions of a porous substrate than a predetermined portion and immersing the whole porous substrate in a solution of a predetermined ion exchange resin.

The porous substrate is preferably a porous film comprising at least one selected from the group consisting of polyolefin resins (e.g., polyethylene, polypropylene, and ethylene-propylene copolymer), polyimide resins (e.g., polyimides and polyamide-imides), polyamide resins (e.g., wholly aromatic polyamides such as aramids), and polytetrafluoroethylene resins (e.g., polytetrafluoroethylene, tetrafluoroethylene-hexafluoropropylene copolymer, tetrafluoroethylene-perfluoroalkylvinylether copolymer, and tetrafluoroethylene-ethylene copolymer).

It should be noted that in any of the above-described means, two or more ion exchange resins may be used in combination so that the ion exchange capacity of each region of the electrolyte membrane per unit volume becomes a predetermined value.

The ion exchange resin contained in the electrolyte membrane upstream of the fuel flow channel is preferably composed only of a sulfonated hydrocarbon resin, or is preferably composed mainly of such a resin. In particular, it is preferable that the ion exchange resin contained in the low capacity region 40 be composed only of a sulfonated hydrocarbon resin, or be composed mainly of such a resin. When the ion exchange resin is composed mainly of a sulfonated hydrocarbon resin, the amount of the sulfonated hydrocarbon resin can be suitably adjusted so that the ion exchange capacity of the low capacity region 40 per unit volume is in a suitable range (e.g., 0.3 to 1.2 meq/cm³).

The ion exchange resin contained in the electrolyte membrane downstream of the fuel flow channel is preferably composed only of a perfluorosulfonic acid resin, or is preferably composed mainly of a perfluorosulfonic acid resin. In particular, it is preferable that the ion exchange resin contained in the high capacity region 42 be composed only of a perfluorosulfonic acid resin, or be composed mainly of a perfluorosulfonic acid resin. When the ion exchange resin is composed mainly of a perfluorosulfonic acid resin, the amount of the perfluorosulfonic acid resin can be suitably adjusted so that the ion exchange capacity of the high capacity region 42 per unit volume is in a suitable range (e.g., 1.3 to 2.5 meq/cm³).

When a perfluorosulfonic acid resin and a sulfonated hydrocarbon resin are compared on the condition that they have the same ion exchange capacity per unit volume, the sulfonated hydrocarbon resin exhibits a smaller volume expansion than the perfluorosulfonic acid resin. Thus, the sulfonated hydrocarbon resin can more effectively suppress the formation of cluster structure of the sulfonic acid group and reduce the amount of water and fuel retained in the resin. As a result, the sulfonated hydrocarbon resin can reduce the permeability of fuel such as methanol into the electrolyte membrane upstream of the fuel flow channel, thereby reducing fuel crossover.

The thickness of the whole electrolyte membrane 10 is preferably uniform. The components of a cell and a stack basically have a uniform thickness, and the whole cell and the whole stack are clamped by applying a uniform pressure in the thickness direction. Hence, if the thickness of the electrolyte membrane 10 is changed, the thickness of other portion(s) of the MEA, such as a catalyst layer or a diffusion layer, needs to be changed to absorb the change of the thickness of the electrolyte membrane 10. This results in an unnecessary change in the balance of the MEA, which may lower the power generation characteristics of the whole MEA. By making the thickness of the whole electrolyte membrane uniform, it is possible to suppress deterioration of power generation characteristics caused by uneven thickness.

The thickness of the electrolyte membrane 10 is 20 to 150 μm, and preferably 30 to 120 μm.

The direct oxidation fuel cell of the invention is characterized by the use of the above-described electrolyte membrane. The other components than the electrolyte membrane are not particularly limited, and for example, the same components as those of conventional direct oxidation fuel cells can be used. Referring again to FIG. 1, the respective components are hereinafter described.

The cathode catalyst layer 18 includes a cathode catalyst and a polymer electrolyte. The cathode catalyst is preferably a noble metal with high catalytic activity such as platinum. Also, an alloy of platinum and cobalt or the like can be used as the cathode catalyst. The cathode catalyst can be used with or without a support. The support is preferably a carbon material such as carbon black since it has high electronic conductivity and high acid resistance. The polymer electrolyte is preferably a proton conductive material such as a perfluorosulfonic acid polymer material or a sulfonated hydrocarbon polymer material. Examples of perfluorosulfonic acid polymer materials include Nafion® and Flemion®.

The cathode catalyst layer 18 can be produced, for example, as follows. A cathode catalyst or a supported cathode catalyst, a polymer electrolyte, and a dispersion medium such as water or an alcohol are mixed to prepare an ink for forming a cathode catalyst layer. The ink is applied onto a substrate sheet made of PTFE by a method such as doctor blade application or spraying, and dried to obtain the cathode catalyst layer 18. The cathode catalyst layer 18 is then transferred from the substrate sheet to the electrolyte membrane 10.

Alternatively, the cathode catalyst layer 18 can be formed directly on the electrolyte membrane 10 by applying the ink for forming a cathode catalyst layer onto the electrolyte membrane 10 and drying it.

The anode catalyst layer 16 includes an anode catalyst and a polymer electrolyte. The anode catalyst is preferably a noble metal with high catalytic activity such as platinum. Also, in terms of reducing catalyst poisoning by carbon monoxide, it is more preferable to use an alloy of platinum and ruthenium as the anode catalyst. The anode catalyst can be used with or without a support. The support can be a carbon material such as carbon black, similarly to the cathode catalyst. The polymer electrolyte can be the same material used for the cathode catalyst layer.

The anode catalyst layer can be produced in the same manner as the cathode catalyst layer.

As described above, the anode diffusion layer 17 includes the conductive water-repellent layer 171 and the substrate layer 172, while the cathode diffusion layer 19 includes the conductive water-repellent layer 191 and the substrate layer 192. Each of the conductive water-repellent layers 171 and 191 includes a conductive material and a water repellent material. The substrate layers 172 and 192 are made of a conductive porous material.

The conductive material contained in the conductive water-repellent layers 171 and 191 can be any material commonly used in the field of fuel cells. Examples of the conductive material include carbon powders such as carbon black and flake graphite; and carbon fibers such as carbon nanotubes and carbon nonofibers. These conductive materials can be used singly or in combination.

The water repellent material contained in the conductive water-repellent layers 171 and 191 can be any material commonly used in the field of fuel cells. Specifically, the water repellent material is preferably, for example, a fluorocarbon resin. The fluorocarbon resin can be any known material in the art. Examples of the fluorocarbon resin include polytetrafluoroethylene (PTFE), tetrafluoroethylene-hexafluoropropylene copolymer (FEP), tetrafluoroethylene-perfluoroalkylvinylether copolymer, tetrafluoroethylene-ethylene copolymer, and polyvinylidene fluoride. Among them, for example, PTFE and FEP are preferable. These water repellent materials can be used singly or in combination.

The conductive water-repellent layers 171 and 191 are formed on the surfaces of the substrate layers 172 and 192, respectively. The methods of forming the conductive water-repellent layers 171 and 191 are not particularly limited. For example, a conductive material and a water repellent material are dispersed in a predetermined dispersion medium to prepare a paste for forming a conductive water-repellent layer. This paste is applied onto a surface of a substrate layer by doctor blade application or spraying and then dried. In this way, a conductive water-repellent layer can be formed on the surface of the substrate layer.

As described above, the substrate layers 172 and 192 are made of a conductive porous material. The conductive porous material can be any material commonly used in the field of fuel cells. The conductive porous material is preferably a highly electron-conductive material having good diffusibility of fuel or oxidant. Examples of such materials include carbon paper, carbon cloth, and carbon non-woven fabric. These porous materials may contain a water repellent material in order to improve the diffusion of fuel and removal of product water. The water repellent material may be the same material as the water repellent material contained in the conductive water-repellent layer. The method of adding a water repellent material to a porous material is not particularly limited. For example, a porous material is immersed in a dispersion of a water repellent material and dried to obtain a substrate layer comprising the porous material containing the water repellent material.

A liquid fuel can be used as the fuel supplied to the anode, and examples include lower alcohols such as methanol, ethanol, and ethylene glycol, aliphatic ethers such as dimethyl ether, lower aliphatic carboxylic acids such as formic acid, and aqueous solutions thereof. Among them, an aqueous solution with a methanol concentration of 1 mol/L to 8 mol/L is preferable as the fuel. The methanol concentration in the methanol aqueous solution is preferably 3 mol/L to 8 mol/L, and more preferably 3 mol/L to 5 mol/L. A higher methanol concentration leads to a greater reduction in the size and weight of the whole fuel cell system, but may cause a larger amount of MCO. According to the invention, since MCO can be reduced, it is possible to use a methanol aqueous solution with a higher methanol concentration than conventional concentrations. If the methanol concentration is lower than 1 mol/L, it may be difficult to miniaturize the fuel cell system. If the methanol concentration exceeds 8 mol/L, MCO may not be sufficiently reduced. When a fuel with such a methanol concentration as described above is used together with the electrolyte membrane of the invention, it is possible to reduce MCO through the electrolyte membrane upstream of the fuel flow channel while ensuring good supply of methanol to the electrolyte membrane downstream of the fuel flow channel.

While the material of the anode-side separator and the cathode-side separator is not particularly limited, the material of the anode-side separator and the cathode-side separator is preferably a carbon material, a metal material coated with carbon, or the like, due to its high electronic conductivity and acid resistance. The anode-side separator has a fuel flow channel for supplying a fuel to the anode. The cathode-side separator has an oxidant flow channel for supplying an oxidant to the cathode. The shape of the fuel flow channel and the oxidant flow channel is not particularly limited. The fuel flow channel and the oxidant flow channel can have a shape such as a serpentine or parallel shape.

### Example

The invention is hereinafter described specifically by way of Examples, but the invention is not to be construed as being limited to the following Examples.

### Example 1

### (a) Preparation of Electrolyte Membrane

An electrolyte membrane with three regions was prepared.

A cross-linked polyethylene film (10 cm×10 cm, thickness 50 μm, porosity 65%) was used as a porous substrate. The porous substrate was divided into three regions: 4 cm×10 cm, 2 cm×10 cm, and 4 cm×10 cm, which were designated as an upstream portion, a midstream portion, and a downstream portion, respectively. The upstream portion, the midstream portion, and the downstream portion correspond to the low capacity region, the middle capacity region, and the high capacity region of the electrolyte membrane, respectively.

The porosity of the upstream portion and the midstream portion of the porous substrate was lowered in advance. To lower the porosity, the upstream portion and the midstream portion were impregnated with a solution of polyvinylidene fluoride (PVDF) (KF polymer available from Kureha Corporation) to fill PVDF therein.

Specifically, first, only the upstream portion of the porous substrate was impregnated with a 3 wt % solution of PVDF, and the porous substrate was dried at a reduced pressure to remove the solvent. In this way, PVDF was filled in the upstream portion. Subsequently, PVDF was filled in the midstream portion in the same manner as described above except that only the midstream portion of the porous substrate was impregnated with a 1 wt % solution of PVDF. The porosities of the upstream portion, the midstream portion, and the downstream portion of the porous substrate were 30%, 43%, and 65%, respectively.

The porosity of each portion of the porous substrate was obtained by measuring the thickness and the weight, calculating the apparent density from the measured values, and dividing the true density by the calculated value. The true density was calculated from the true density of the porous substrate, the true density of PVDF, and the amount of PVDF.

Thereafter, an ion exchange resin was filled in the porous substrate. Specifically, the porous substrate was immersed in a dispersion of Nafion® (5 wt % Nafion solution available from Sigma-Aldrich Japan K.K.) serving as an ion exchange resin. The porous substrate impregnated with the dispersion of the ion exchange resin was dried at a reduced pressure to remove the solvent. In this way, an electrolyte membrane comprising the porous substrate and the ion exchange resin filled therein was obtained. The electrolyte membrane had a thickness of 50 μm.

The ion exchange capacity of each region of the electrolyte membrane per unit volume was measured as follows. A sample of an electrolyte membrane was prepared in the same manner as described above. The sample was cut to three regions: a low capacity region, a middle capacity region, and a high capacity region. Using neutralization titration, the ion exchange capacities of the respective regions per unit volume were obtained. Specifically, the amount (equivalent) of protons derived from the ion exchange group, as determined by neutralization titration, was divided by the volume of each region, to obtain the ion exchange capacity of each region per unit volume.

The ion exchange capacities of the low capacity region, the middle capacity region, and the high capacity region per unit volume were 0.6 meq/cm³, 1.0 meq/cm³, and 1.4 meq/cm³, respectively.

### (b) Preparation of Cathode Catalyst Layer

A Pt catalyst was used as a cathode catalyst. The Pt catalyst was supported on ketjen black (ECP available from Ketjen black International Company Ltd.) to obtain a supported cathode catalyst. The mass ratio of ketjen black to Pt was such that ketjen black:Pt=50:50. A dispersion of the supported cathode catalyst in an isopropanol aqueous solution was mixed with a dispersion of Nafion® (5 wt % Nafion solution available from Sigma-Aldrich Japan K.K.) serving as a polymer electrolyte, to prepare an ink for forming a cathode catalyst layer. This ink was applied onto a 6 cm×6 cm polytetrafluoroethylene (PTFE) sheet with a spray coater, and dried to obtain a cathode catalyst layer.

### (c) Preparation of Anode Catalyst Layer

A Pt—Ru alloy catalyst (Pt:Ru=1:1 (atomic ratio)) was used as an anode catalyst. The Pt—Ru alloy catalyst was supported on ketjen black, described above, to obtain a supported anode catalyst. The mass ratio of ketjen black to Pt—Ru was such that ketjen black:Pt—Ru=50:50. An ink for forming an anode catalyst layer was prepared in the same manner as the ink for forming a cathode catalyst layer, except for the use of the supported anode catalyst. The ink for forming an anode catalyst layer was applied onto a 6 cm×6 cm PTFE sheet with a spray coater, and dried to obtain an anode catalyst layer.

### (d) Preparation of Paste for Forming Conductive Water-Repellent Layer

A dispersion of a water repellent material and a conductive material were dispersed and mixed in ion-exchange water to which a surfactant had been added, to prepare a paste for forming a conductive water-repellent layer. A PTFE dispersion (PTFE content 60 mass %, available from Sigma-Aldrich Japan K.K.) was used as the dispersion of water-repellent material. Acetylene black (DENKA BLACK available from Denki Kagaku Kogyo K.K.) was used as the conductive material. The mass ratio of acetylene black to PTFE was set to 50:50.

### (e) Formation of Substrate Layer

A carbon paper (TGP-H-090, thickness 280 μm, available from Toray Industries Inc.) was used as the conductive porous material constituting the anode substrate layer of the anode diffusion layer. The carbon paper was immersed in a dispersion of PTFE (water repellent material) (available from Sigma-Aldrich Japan K.K.) and dried. In this way, the carbon paper was made water-repellent.

A carbon cloth (AvCarb® 1071HCB available from Ballard Material Products Inc.) was used as the conductive porous material constituting the cathode substrate layer of the cathode diffusion layer. This carbon cloth was also made water-repellent in the same manner as described above.

### (f) Formation of Anode Diffusion Layer and Cathode Diffusion Layer

The paste for forming a conductive water-repellent layer, prepared in (d), was applied onto one face of the anode substrate layer prepared in (e), and then dried to form an anode diffusion layer. Likewise, the paste for forming a conductive water-repellent layer, prepared in (d), was applied onto one face of the cathode substrate layer prepared in (e), and then dried to form a cathode diffusion layer.

### (g) Production of Membrane Electrode Assembly (MEA)

The cathode catalyst layer formed on the PTFE sheet was disposed on one face of the electrolyte membrane with a size of 10 cm×10 cm, while the anode catalyst layer formed on the PTFE sheet was disposed on the other face of the electrolyte membrane. The cathode catalyst layer and the anode catalyst layer were bonded to the electrolyte membrane by hot pressing, and the PTFE sheets were separated therefrom. It is noted that the cathode catalyst layer and the anode catalyst layer were disposed on the electrolyte membrane so that the edge of the electrolyte membrane was exposed 2 cm around each of the catalyst layers.

Subsequently, the cathode diffusion layer was bonded to the cathode catalyst layer, while the anode diffusion layer was bonded to the anode catalyst layer. In this way, a membrane electrode assembly (MEA) was produced.

### (h) Production of Fuel Cell

A rubber gasket was fitted to each side of the electrolyte membrane of the MEA so as to cover the whole exposed part of the electrolyte membrane. The MEA was sandwiched between an anode-side separator made of carbon and a cathode-side separator made of carbon. The face of the anode-side separator in contact with the anode was provided with a fuel flow channel for supplying a fuel to the anode. The face of the cathode-side separator in contact with the cathode was provided with an oxidant flow channel for supplying an oxidant to the cathode. The fuel flow channel and the oxidant flow channel were serpentine.

Thereafter, the anode-side separator and the cathode-side separator were sandwiched between current collector plates, heaters, insulator plates, and end plates in this order. The resulting stack was clamped with predetermined clamping means. In this way, a direct oxidation fuel cell (direct methanol fuel cell) of Example 1 was produced. It is noted that in the following evaluation test, the current collector plates were connected to an electronic load unit.

### (i) Evaluation of Power Generation Characteristics

Power was generated as follows. Air was supplied to the cathode of the fuel cell thus obtained, while a 2 mol/L methanol aqueous solution was supplied to the anode. The fuel cell was connected to the electronic load unit and operated to generate power at a constant current of 150 mA/cm² for a power generation time of 60 minutes. The temperature of the fuel cell was kept at 60° C. The air utilization rate was set to 50%, while the fuel utilization rate was set to 70%.

The average voltage during the power generation time of 60 minutes was obtained as a power generation characteristic, and the power generation efficiency was obtained using the following formula (1):

Power generation efficiency (fuel efficiency)=current generated/(current generated+current converted from MCO) formula (1)

MCO was obtained as follows. The methanol concentration in the anode effluent was measured by a gas chromatograph. Based on the methanol concentration in the methanol aqueous solution supplied to the anode, the concentration of methanol (amount of methanol) used in the power generation, and the methanol concentration in the anode effluent, the material balance in the anode was calculated to obtain MCO.

The results are shown in Table 1.

### Example 2

A cross-linked polyethylene film, which was the same as the one used in Example 1, was used as a porous substrate. Sulfonated polyetheretherketone (SPEEK) resin prepared in the following manner was used as an ion exchange resin.

95 wt % concentrated sulfuric acid was introduced into a reaction vessel, and polyetheretherketone (available from Sigma-Aldrich Japan K.K.) was added to the concentrated sulfuric acid with stirring. The resulting reaction solution was stirred at room temperature for a predetermined time. The reaction solution was dropped into ion-exchange water to precipitate a reaction product, and the reaction product was filtered and washed with ion-exchange water. The resulting reaction product was dried to obtain SPEEK.

The time of stirring in the sulfuric acid was changed to 10 hours, 30 hours, and 40 hours to obtain three kinds of SPEEK with different ion exchange capacities per unit volume. The three kinds of SPEEK obtained by stirring for 10 hours, 30 hours, and 40 hours were designated as SPEEK (1), SPEEK (2), and SPEEK (3), respectively. SPEEK (3) had the largest ion exchange capacity per unit volume, and SPEEK (1) had the smallest ion exchange capacity per unit volume.

Each solid SPEEK was dissolved in N,N′-dimethylformamide and diluted with an isopropanol aqueous solution to obtain a solution of each SPEEK.

The porous substrate was divided into three regions: 4 cm×10 cm, 2 cm×10 cm, and 4 cm×10 cm, which were designated as an upstream portion, a midstream portion, and a downstream portion, respectively. First, only the upstream portion was impregnated with the solution of SPEEK (1) and dried at a reduced pressure to remove the solvent. In this way, SPEEK (1) was filled in the upstream portion. Subsequently, SPEEK (2) was filled in the midstream portion in the same manner as described above except that only the midstream portion was impregnated with the solution of SPEEK (2). Lastly, SPEEK (3) was filled in the downstream portion in the same manner as described above except that only the downstream portion was impregnated with the solution of SPEEK (3). In this way, an electrolyte membrane including the low capacity region, the middle capacity region, and the high capacity region was obtained.

In the same manner as in Example 1, the ion exchange capacity of each region of the electrolyte membrane per unit volume was obtained. As a result, the ion exchange capacities of the low capacity region, the middle capacity region, and the high capacity region per unit volume were 0.5 meq/cm³, 0.9 meq/cm³, and 1.3 meq/cm³, respectively.

A direct oxidation fuel cell of Example 2 was produced in the same manner as in Example 1 except for the use of the electrolyte membrane obtained in the above manner.

This fuel cell was evaluated for power generation characteristic and fuel efficiency in the same manner as in Example 1. The results are shown in Table 1.

### Example 3

An electrolyte membrane was produced in the same manner as in Example 2, except that Nafion used in Example 1 was filled in the downstream portion of the porous substrate instead of SPEEK (3).

A direct oxidation fuel cell of Example 3 was produced in the same manner as in Example 1 except for the use of the electrolyte membrane thus obtained.

The fuel cell was evaluated for power generation characteristic and fuel efficiency in the same manner as in Example 1. The results are shown in Table 1.

### Example 4

In the same manner as in Example 2, three kinds of SPEEK (1) to (3) with different ion exchange capacities per unit volume were used.

The respective solutions of SPEEK (1) to (3) were applied onto different regions of an application area (10 cm×10 cm) of a PTFE sheet by doctor blade application. Specifically, the 10 cm×10 cm application area of the PTFE sheet was divided into three regions: 4 cm×10 cm, 2 cm×10 cm, and 4 cm×10 cm, which were designated as an upstream portion, a midstream portion, and a downstream portion, respectively.

First, with the midstream portion and the downstream portion being masked, the solution of SPEEK (1) was applied onto only the upstream portion, and dried. Then, with the upstream portion and the downstream portion being masked, the solution of SPEEK (2) was applied onto only the midstream portion, and dried. Lastly, with the upstream portion and the midstream portion being masked, the solution of SPEEK (3) was applied onto only the downstream portion, and dried. In this way, an electrolyte membrane with the low capacity region, the middle capacity region, and the high capacity region was obtained. The electrolyte membrane was separated from the PTFE sheet.

The ion exchange capacities of the low capacity region, the middle capacity region, and the high capacity region per unit volume are obtained in the same manner as in Example 1. As a result, the ion exchange capacities of the low capacity region, the middle capacity region, and the high capacity region per unit volume were 0.7 meq/cm³, 1.3 meq/cm³, and 1.9 meq/cm³, respectively. Also, the thickness of the whole electrolyte membrane was almost uniform and 50 μm.

A direct oxidation fuel cell of Example 4 was produced in the same manner as in Example 1 except for the use of the electrolyte membrane thus produced.

The fuel cell was evaluated for power generation characteristic and fuel efficiency in the same manner as in Example 1. The results are shown in Table 1.

### Example 5

A direct oxidation fuel cell was produced in the same manner as in Example 1. The fuel cell was evaluated for power generation characteristic and fuel efficiency in the same manner as in Example 1, except that the concentration of the methanol aqueous solution supplied to the fuel cell was set to 4 mol/L. The results are shown in Table 1.

### Comparative Example 1

A direct oxidation fuel cell of Comparative Example 1 was produced in the same manner as in Example 1, except for the use of Nafion 112 (thickness 50 μm available from E.I. Du Pont de Nemours & Co. Inc.) as the electrolyte membrane. The ion exchange capacity of the electrolyte membrane per unit volume was measured in the same manner as in Example 1, and it was found to be 1.9 meq/cm³.

The fuel cell was evaluated for power generation characteristic and fuel efficiency in the same manner as in Example 1. The results are shown in Table 1.

### Comparative Example 2

An electrolyte membrane was produced by applying the solution of SPEEK (2) prepared in Example 2 onto the whole application area (10 cm×10 cm) of a PTFE sheet by doctor blade application, and drying it. The electrolyte membrane was separated from the PTFE sheet.

The thickness of the whole electrolyte membrane was almost uniform and 50 μm. Also, the ion exchange capacity of the electrolyte membrane per unit volume was 1.3 meq/cm³.

A direct oxidation fuel cell of Comparative Example 2 was produced in the same manner as in Example 1 except for the use of the electrolyte membrane thus produced.

The fuel cell was evaluated for power generation characteristic and fuel efficiency in the same manner as in Example 1. The results are shown in Table 1.

### Comparative Example 3

An electrolyte membrane was produced in the same manner as in Comparative Example 2, except that in doctor blade application, the gap between the blade and the PTFE sheet was gradually changed.

The thickness of the edge of the electrolyte membrane upstream of the fuel flow channel was 65 μm, while the thickness of the edge downstream of the fuel flow channel was 35 μm. Also, the ion exchange capacity of the electrolyte membrane per unit volume was 1.3 meq/cm³.

A direct oxidation fuel cell of Comparative Example 3 was produced in the same manner as in Example 1 except for the use of the electrolyte membrane thus produced.

The fuel cell was evaluated for power generation characteristic and fuel efficiency in the same manner as in Example 1. The results are shown in Table 1.

### Comparative Example 4

An electrolyte membrane was produced in the same manner as in Example 1, except that only Nafion used in Example 1 was filled in the whole porous substrate used in Example 1. The ion exchange capacity of the electrolyte membrane per unit volume was 1.4 meq/cm³.

A direct oxidation fuel cell of Comparative Example 4 was produced in the same manner as in Example 1 except for the use of the electrolyte membrane thus produced.

The fuel cell was evaluated for power generation characteristic and fuel efficiency in the same manner as in Example 1. The results are shown in Table 1.

### Comparative Example 5

A direct oxidation fuel cell was produced in the same manner as in Comparative Example 1. The fuel cell was evaluated for power generation characteristic and fuel efficiency in the same manner as in Example 1, except that the concentration of the methanol aqueous solution supplied to the fuel cell was set to 4 mol/L. The results are shown in Table 1.

TABLE 1

| | Ion exchange capacity (meg/cm³) | | | Power | |
|---|---|---|---|---|---|
| | Low | Middle | High | generation | |
| | capacity | capacity | capacity | characteristic | Fuel |
| | region | region | region | (v) | efficiency |
| Example 1 | 0.6 | 1.0 | 1.4 | 0.47 | 0.82 |
| Example 2 | 0.5 | 0.9 | 1.3 | 0.42 | 0.87 |
| Example 3 | 0.5 | 0.9 | 1.4 | 0.46 | 0.86 |
| Example 4 | 0.7 | 1.3 | 1.9 | 0.45 | 0.83 |
| Example 5 | 0.6 | 1.0 | 1.4 | 0.46 | 0.79 |

| | | | |
|---|---|---|---|
| Comp. | 1.9 | 0.38 | 0.73 |
| Example 1 | | | |
| Comp. | 1.3 | 0.35 | 0.75 |
| Example 2 | | | |
| Comp. | 1.3 | 0.32 | 0.73 |
| Example 3 | | | |
| Comp. | 1.4 | 0.36 | 0.76 |
| Example 4 | | | |
| Comp. | 1.9 | 0.33 | 0.67 |
| Example 5 | | | |

The fuel cells of Examples 1 to 5, in which the ion exchange capacity of the electrolyte membrane per unit volume was made smaller upstream of the fuel flow channel than downstream thereof, were significantly improved in both power generation characteristic and fuel efficiency, compared with the fuel cells of Comparative Examples 1 to 5, which used the electrolyte membrane with a uniform ion exchange capacity per unit volume. The reasons for the improvement in power generation characteristic and fuel efficiency are probably that MOC was reduced upstream of the fuel flow channel and that sufficient proton conductivity was ensured downstream thereof.

The fuel cell of Example 1 using a perfluorosulfonic acid resin had a relatively good power generation characteristic. The fuel cells of Examples 2 to 4 using a sulfonated hydrocarbon resin had a relatively good power generation efficiency. The fuel cell of Example 3, which included a sulfonated hydrocarbon resin in the low capacity region upstream of the fuel flow channel and included a perfluorosulfonic acid resin in the high capacity region downstream of the fuel flow channel, was relatively good both in power generation characteristic and fuel efficiency, compared with the fuel cells of the other Examples. This is probably because the effects of reducing MCO and ensuring sufficient proton conductivity in the fuel cell 3 are more effective and balanced than those in the fuel cells of the other Examples.

Example 5, which used a methanol aqueous solution with a high concentration of 4 mol/L, also had a good power generation characteristic. Also, the difference in battery characteristics between the fuel cell of Example 5 and the fuel cell of Comparative Example 5 using a 4 mol/L methanol aqueous solution is larger than the difference in battery characteristics between the fuel cell of Example 1 and the fuel cell of Comparative Example 1 both of which used a 2 mol/L methanol aqueous solution. This indicates that the invention is very effective for high concentration methanol. The use of high concentration methanol allows the fuel cell system to become more compact.

In the fuel cell of Comparative Example 3, the electrolyte membrane was made thinner from upstream of the fuel flow channel toward downstream thereof. The fuel cell of Comparative Example 3 had a lower power generation characteristic and a lower fuel efficiency than the fuel cell of Comparative Example 2, in which the thickness of the electrolyte membrane was uniform. In the fuel cell of Comparative Example 3, since the thickness of the electrolyte membrane was changed, it is believed that the compression rate of the catalyst layers, diffusion layers, and the like was changed between upstream and downstream of the fuel flow channel to make the thickness of the cell uniform, thereby resulting in a change in the thickness and porosity of the catalyst layers, diffusion layers, and the like. This is probably a reason why the power generation characteristic lowered.

As described above, it has been found that the invention can provide a direct oxidation fuel cell that is improved in power generation characteristics and power generation efficiency.

The direct oxidation fuel cell of the invention has good power generation characteristics and power generation efficiency. Thus, the use of the fuel cell of the invention enables an improvement in the performance of the fuel cell system. Therefore, the direct oxidation fuel cell of the invention is very useful as the power source for small-sized devices such as cellular phones and notebook personal computers.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A direct oxidation fuel cell comprising at least one cell, the cell comprising:
a membrane electrode assembly comprising an anode, a cathode, and an electrolyte membrane disposed between the anode and the cathode;
an anode-side separator being in contact with the anode and having a fuel flow channel for supplying a fuel to the anode; and
a cathode-side separator being in contact with the cathode and having an oxidant flow channel for supplying an oxidant to the cathode,
wherein the electrolyte membrane including an ion exchange resin and having an ion exchange capacity per unit volume which is smaller upstream of the fuel flow channel than downstream thereof.

2. The direct oxidation fuel cell in accordance with claim 1, wherein the ion exchange capacity of the electrolyte membrane per unit volume increases stepwise from upstream toward downstream of the fuel flow channel.

3. The direct oxidation fuel cell in accordance with claim 1, wherein the ion exchange capacity of the electrolyte membrane per unit volume increases continuously from upstream toward downstream of the fuel flow channel.

4. The direct oxidation fuel cell in accordance with claim 1, wherein the electrolyte membrane has a low capacity region with an ion exchange capacity per unit volume of 0.3 to 1.2 meq/cm³ upstream of the fuel flow channel.

5. The direct oxidation fuel cell in accordance with claim 4, wherein the electrolyte membrane has a power generation region, and the low capacity region overlaps ⅓ to ⅙ of the power generation region from an upstream side end thereof.

6. The direct oxidation fuel cell in accordance with claim 1, wherein the electrolyte membrane has a high capacity region with an ion exchange capacity per unit volume of 1.3 to 2.5 meq/cm³ downstream of the fuel flow channel.

7. The direct oxidation fuel cell in accordance with claim 1, wherein the electrolyte membrane includes a porous substrate, the ion exchange resin is filled in the porous substrate, and the porosity of the porous substrate is smaller upstream of the fuel flow channel than downstream thereof.

8. The direct oxidation fuel cell in accordance with claim 7, wherein the porous substrate has a low-porosity region with a porosity of 20 to 45% upstream of the fuel flow channel, and has a high-porosity region with a porosity of 50 to 80% downstream of the fuel flow channel.

9. The direct oxidation fuel cell in accordance with claim 7, wherein the porous substrate is a porous film comprising at least one selected from the group consisting of polyolefin resins, polyimide resins, polyamide resins, and polytetrafluoroethylene resins.

10. The direct oxidation fuel cell in accordance with claim 1,
wherein the electrolyte membrane includes a porous substrate and two or more of the ion exchange resins having different ion exchange capacities per unit volume,
the ion exchange resins are filled in the porous substrate, and
the electrolyte membrane has the ion exchange resin with the smallest ion exchange capacity per unit volume upstream of the fuel flow channel, and has the ion exchange resin with the largest ion exchange capacity per unit volume downstream of the fuel flow channel.

11. The direct oxidation fuel cell in accordance with claim 1, wherein the ion exchange resin includes at least one selected from the group consisting of a perfluorosulfonic acid resin and a sulfonated hydrocarbon resin.

12. The direct oxidation fuel cell in accordance with claim 11, wherein the electrolyte membrane includes the sulfonated hydrocarbon resin upstream of the fuel flow channel, and includes the perfluorosulfonic acid resin downstream of the fuel flow channel.

13. The direct oxidation fuel cell in accordance with claim 1, wherein the electrolyte membrane has a uniform thickness.

14. The direct oxidation fuel cell in accordance with claim 1, wherein the fuel is methanol or a methanol aqueous solution.

15. The direct oxidation fuel cell in accordance with claim 14, wherein the methanol aqueous solution has a methanol concentration of 3 mol/L to 8 mol/L.
